(19) United States
(12) Patent Application Publication
(10) Pub. No.: US 2010/0321272 A1
(43) Pub. Date: Dec. 23, 2010

(54) ANTENNA DEVICE

(75) Inventors: Shinsuke Yukimoto, Tokyo (JP); Takao Yokoshima, Tokyo (JP)

Correspondence Address: CARTER, DELUCA, FARRELL & SCHMIDT, LLP, 445 BROAD HOLLOW ROAD, SUITE 420, MELVILLE, NY, 11747, US

(73) Assignees: MITSUBISHI CABLE INDUSTRIES, LTD., Tokyo (JP); MITSUBISHI MATERIALS CORPORATION, Tokyo (JP)

(21) Appl. No.: 12/742,712

(22) PCT Filed: Nov. 21, 2008
(86) PCT No.: PCT/JP2008/003442

§ 371 Date: Aug. 9, 2010

(30) Foreign Application Priority Data
Nov. 30, 2007 (JP) 2007-311719

(51) Int. Cl. H01Q 1/50

(52) U.S. Cl. 343/860

(57) ABSTRACT

An antenna device is provided with a base material having a power feed section to which a power feed line is connected; an antenna element connected to the power feed section; and a matching circuit section, which is connected to the power feed section and the antenna element and matches the reactance of the antenna element and that of the power feed line with each other. The antenna element is provided with an impedance control section, which is annularly formed and has passive components connected thereto, on an opened leading end section.

### CROSS REFERENCE TO RELATED APPLICATIONS

This application claims the benefit of priority from Japanese Patent Application No. 2007-311719 filed on Nov. 30, 2007. The contents of which, is hereby incorporated by reference in its entirety.

### TECHNICAL FIELD

The present disclosure relates to an antenna device which is preferable for wireless communication technology such as a vehicle keyless operation system.

### BACKGROUND OF RELATED ART

In recent years, for the purpose of wireless communication such as a keyless operation system for a vehicle, an antenna device utilizing a pattern antenna has been thought. As an antenna device utilizing a pattern antenna, a monopole antenna on which an antenna element with a ¼ length of an antenna operation wavelength is arranged in a pattern on a substrate has been conventionally and generally used. However, since the overall antenna extends in one direction, a downsized inverse L-type antenna which is the monopole antenna bent in the middle is being developed.

Furthermore, in the inverse L-type antenna, a reactance component, which is generated between the ground (GND) plate of a substrate and the horizontal portion of an antenna element parallel to the ground plate, is capacitive and becomes large value, thereby making it difficult to match with respect to a 50Ω power feed line. Hence, in order to facilitate the matching between the antenna element and the 50Ω power feed line, a so-called inverse F-type antenna has conventionally been utilized. The inverse F-type antenna is configured such that a stub which connects the ground plate of a substrate to a radiation element is provided near a power feed section provided in the midway of the antenna element. With this arrangement, it is easy to cancel out the capacitive reactance created by the reactance component so as to achieve matching with the 50Ω power feed line.

In consideration of a reduction in size of the inverse F-type antenna, the characteristic improvement of the pattern antenna is difficult. Hence, for example, as with the conventional art disclosed in Japanese Unexamined Patent Application Publication No. 2005-210665, the entire contents of which is hereby incorporated by reference, a chip antenna using a dielectric has been proposed. However, even if such inverse F-type antenna is used, the impedance at the open end section becomes high when such antenna is subjected to reduction in size, whereby such antenna is susceptible to the influence of components to be mounted to the ground plate on the substrate and around the antenna, human body, and the like. In order to improve this point, it has also been thought to employ a loop antenna that has a reduced impedance by terminating the open end section and thereby is not susceptible to be affected by peripheral influences, as illustrated in Japanese Unexamined Patent Application Publication No. 2000-183631, the entire contents of which is hereby incorporated by reference in its entirety.

However, even in the conventional technique described above, the following problems are still remained.

Specifically, while a conventional loop antenna advantageously provides a lower cost and is not susceptible to be affected by peripheral influences, it nevertheless involves a disadvantage in that such loop antenna is difficult to improve the characteristics such as high gain, directivity, or the like and achieve reduction in size because its characteristics are determined by its open surface area and its effective length.

Thus, there is a need for an antenna device that can control its impedance even if it is affected by peripheral influences, to provide a desired frequency tuning, and to achieve characteristic improvement and reduction in size.

### SUMMARY

The present disclosure provides an antenna device which includes a base material having a power feed section to which a power feed line is connected; an antenna element connected to the power feed section; and a matching circuit section, which is connected to the power feed section and the antenna element and matches the reactance of the antenna element and that of the power feed line with each other, wherein the antenna element comprises an impedance control section, which is annularly formed and has a passive component connected thereto, on an opened leading end section.

### BRIEF DESCRIPTION OF THE DRAWINGS

FIG. 1 is a plan view showing an antenna device according to an embodiment of the present disclosure;

FIG. 2 is an equivalent circuit view of the antenna device of the present embodiment;

FIG. 3 is an equivalent circuit view when polarization and directivity are actually measured with the antenna device of the present embodiment;

FIG. 4 is a graph showing the directional pattern obtained when the polarization and directivity are actually measured with the antenna device of the present embodiment;

FIG. 5A is a plan view of a device showing an example in which an inverse F-type antenna pattern is used as a comparative example of the antenna device according to the present disclosure;

FIG. 5B is an equivalent circuit view when polarization and directivity are actually measured with the antenna device having an inverse F-type antenna pattern according to a comparative example;

FIG. 6 is a graph showing the directional pattern obtained when the polarization and directivity are actually measured with the antenna device having an inverse F-type antenna pattern according to a comparative example;

FIG. 7A is a plan view of a device showing an example in which a loop antenna pattern is used as a comparative example of the antenna device according to the present disclosure;

FIG. 7B is an equivalent circuit view when polarization and directivity are actually measured with the antenna device having a loop antenna pattern according to a comparative example; and

FIG. 8 is a graph showing the directional pattern obtained when the polarization and directivity are actually measured with the antenna device having a loop antenna pattern according to a comparative example.

### DETAILED DESCRIPTION

In order to solve the aforementioned problems, the present disclosure employs the following constitution. Specifically, the antenna device of the present disclosure is provided with a base material having a power feed section to which a power feed line is connected; an antenna element connected to the power feed section; and a matching circuit section, which is connected to the power feed section and the antenna element and matches the reactance of the antenna element and that of the power feed line with each other. The antenna element is provided with an impedance control section, which is annularly formed and has a passive component connected thereto, on an opened leading end section.

Conventionally, an open-ended antenna element has high impedance at the distal end, and thereby such antenna element is susceptible to be affected by the influence of peripheral components and the like. However, since in the antenna device of the present disclosure, the antenna element includes an impedance control section, which is annularly formed (loop-formed) and has passive components such as capacitors or inductors connected thereto, on an opened leading end section, the overall impedance control section including the passive components serves as the open element of antenna, and thereby the impedance at the distal end can be controlled. As a result, the antenna device can provide a desired frequency tuning depending on the settings of the passive components, the shape of the impedance control section, and the like, and characteristic improvement and reduction in size of the device can be achieved.

Also, the antenna device of the present disclosure is characterized in that the impedance control section is divided into a plurality of groups by a plurality of the passive components that are connected together and spaced apart from each other. Specifically, since in the antenna device, the impedance control section is divided into a plurality of groups by a plurality of the passive components that are connected together and spaced apart from each other, a plurality of antenna elements, of which the elongation direction, length, and the like are properly divided and arranged by appropriately setting the divided position of the passive components, are obtained, and thereby the influence of a ground plate, a peripheral component, and the like can be reduced.

Furthermore, the antenna device of the present disclosure is characterized in that the impedance control section is arranged so as to surround other circuit provided on the base material. Specifically, since in the antenna device, the impedance control section is arranged so as to surround other circuit provided on the base material, the open surface area can thereby be set as large as possible.

According to the present disclosure, following effects are obtained.

Specifically, according to the antenna device of the present disclosure, since the antenna element includes an impedance control section, which is annularly formed and has a passive component connected thereto, on an opened leading end section, the impedance at the distal end can be controlled, whereby the antenna device can provide a desired frequency tuning, resulting in favorable antenna characteristics.

Therefore, since the antenna device of the present disclosure is not susceptible to be affected by peripheral influences and thereby characteristic improvement and reduction in size can be achieved, the antenna device of the present disclosure can be preferably used for any one of a receiving antenna device, a transmitting antenna device, and a transmitting/receiving antenna device that are used for vehicle-mounted wireless communication system, in particular, keyless operation system.

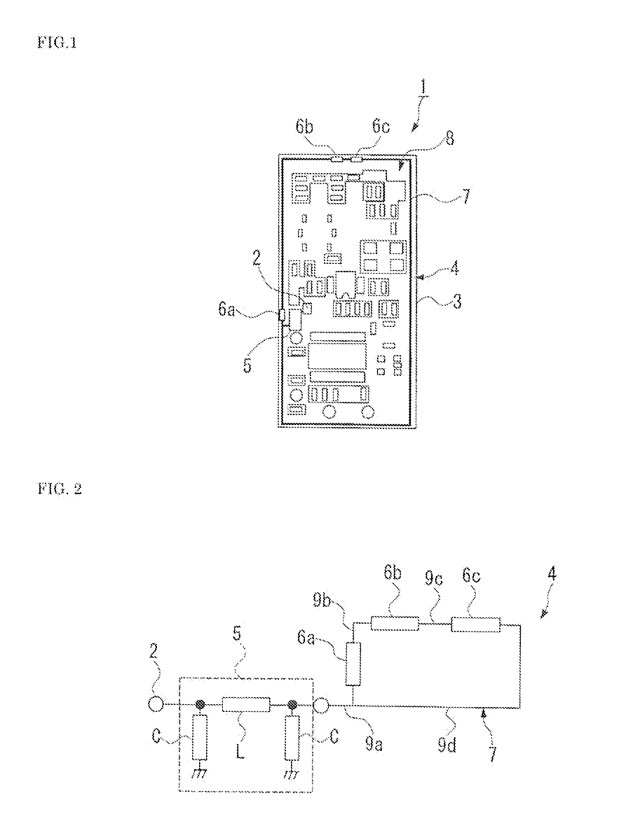

Hereinafter, the antenna device according to an embodiment of the present disclosure will be described with reference to FIGS. 1 to 8.

An antenna device 1 according to the present embodiment is, for example, a receiving antenna device, a transmitting antenna device, or a transmitting/receiving antenna device that is used for vehicle-mounted wireless communication system, in particular, keyless operation system. As shown in FIGS. 1 and 2, the antenna device 1 includes a base material 3 provided with a power feed section 2 to which a 50Ω power feed line (not shown) is connected; an antenna element 4 connected to the power feed section 2 and patterned to form a conductor (such as a copper foil and the like) on the base material 3; and a matching circuit section 5, which is connected to the power feed section 2 and the antenna element 4, provided on the base material 3, and matches the reactance of the antenna element 4 and that of the power feed line with each other.

The antenna element 4 further includes an impedance control section 7 which is annularly formed (loop-formed) and has passive components 6a to 6c connected thereto, on an opened leading end section.

It should be noted that the aforementioned keyless operation system is a system that can perform a lock/unlock operation (so-called “keyless entry system”) of a door, tailgate, and the like of a vehicle, an engine start-up operation, and the like by performing ID code verification through wireless communication between a key and a receiving antenna device provided on a vehicle body side when the driver or the like who carries a key referred to as “keyless operation key” having a wireless communication function approaches the vehicle within the wireless operation range.

The base material 2 is, for example, a wiring substrate or a circuit board. The other circuit 8 such as a wireless communication circuit, an electronic control unit (ECU), and the like, which are not shown, is formed on the upper surface or the lower surface of the base material 2.

As shown in FIG. 2, the matching circuit section 5 has a circuit configuration in which a π-type LC circuit including a plurality of inductances L or capacitors C is provided in a single-stage or multiple-stages. The matching circuit section 5 corresponds to a portion that provides the matching from the power feed section to the stub in the conventional inverse F-type antenna.

The impedance control section 7 is the open element section of the antenna element 4, and is arranged in rectangular form so as to surround other circuit 8 provided on the base material 3. It is advantageous that the impedance control section 7 be elongated with respect to the wavelength of desired frequency.

The impedance control section 7 is divided into a plurality of groups by three passive components 6a to 6c that are connected together and spaced apart from each other. Specifically, as shown in FIG. 2, the antenna element 4 is configured by a first element 9a, which is an antenna pattern from the matching circuit section 5 to the impedance control section 7, and the impedance control section 7, and the impedance control section 7 is configured by a second element 9b, which is an antenna pattern between the passive component 6a and the passive component 6b, a third element 9c, which is an antenna pattern between the passive component 6b and the passive component 6c, and a fourth element 9d, which is an antenna pattern between the passive component 6c and the passive component 6a.

Specifically, the impedance control section 7 is divided into three groups from the second element 9b to the fourth element 9d, and the antenna element 4 is divided into four groups from the first element 9a to the fourth element 9d.

The passive components 6a to 6c are passive elements of typically used inductor or capacitor. Specifically, in association with the variation of the inductance component of the impedance control section 7 by the connection of these passive components 6a to 6c, the antenna element 4 can perform tuning to a desired frequency.

The connection position of these passive components 6a to 6c needs to be designed corresponding to the positional relationship between the longitudinal direction and the transverse direction of the impedance control section 7. When three passive components 6a to 6c are provided as in the present embodiment, the passive components 6a to 6c are designed to provide the positional relationship as shown in FIG. 1, and are connected to the longitudinal direction and the transverse direction of the impedance control section 7, respectively. While in the present embodiment, the passive components 6a to 6c are connected in series in the impedance control section 7, the passive components 6a to 6c may be connected in parallel.

Next, with respect to the antenna device of the present embodiment, a description will be given of the results obtained from the measurement of the actual polarization and directivity.

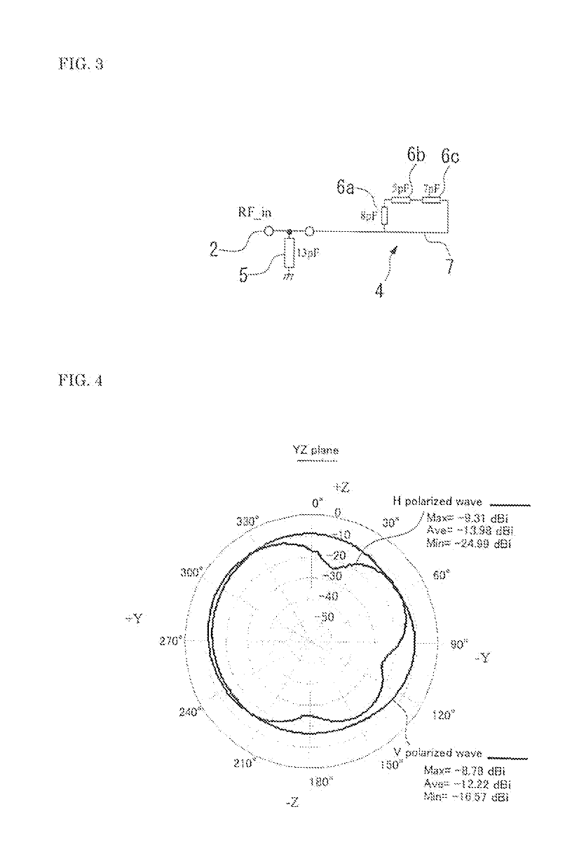

It is assumed that the capacitances of the matching circuit section 5 and the passive components 6a to 6c are 13 pF, 8 pF, 5 pF, and 7 pF, respectively, as shown in FIG. 3. The directional pattern in this case is shown in FIG. 4.

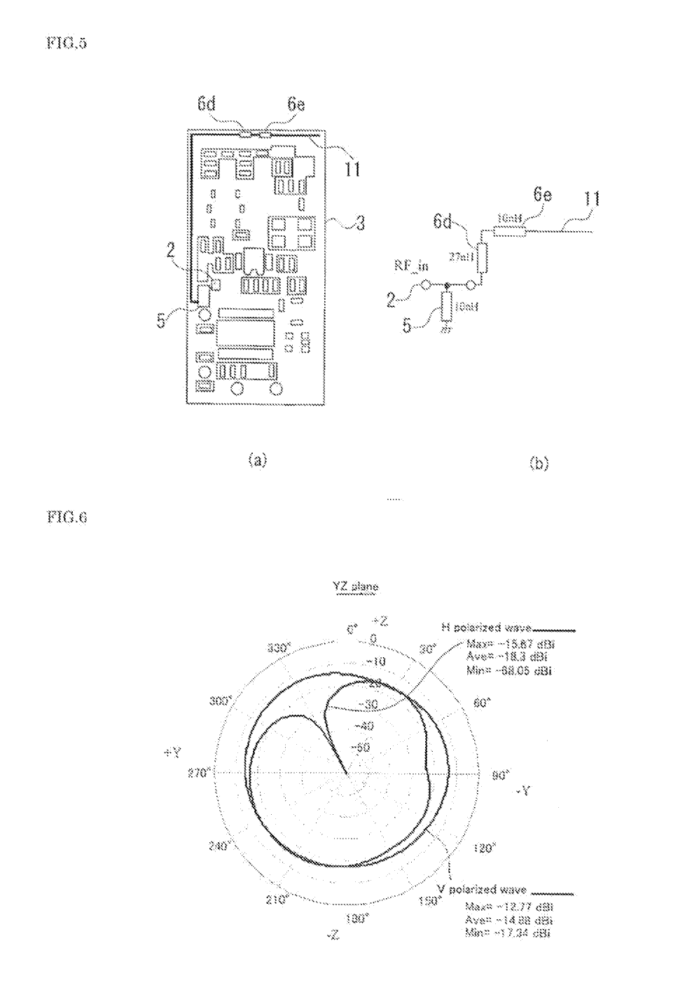

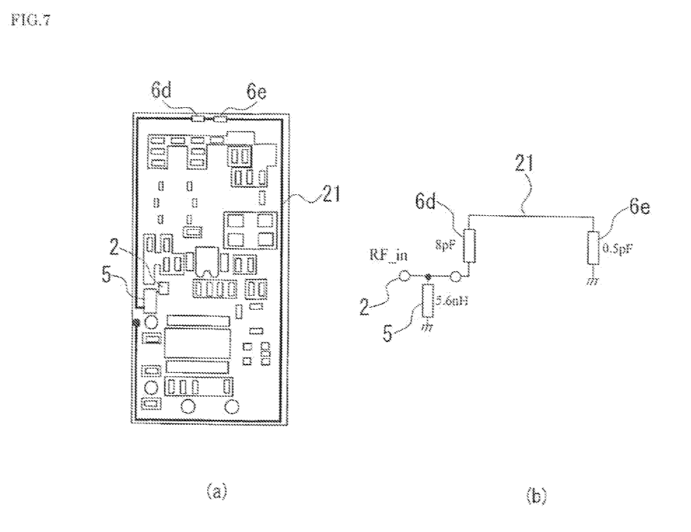

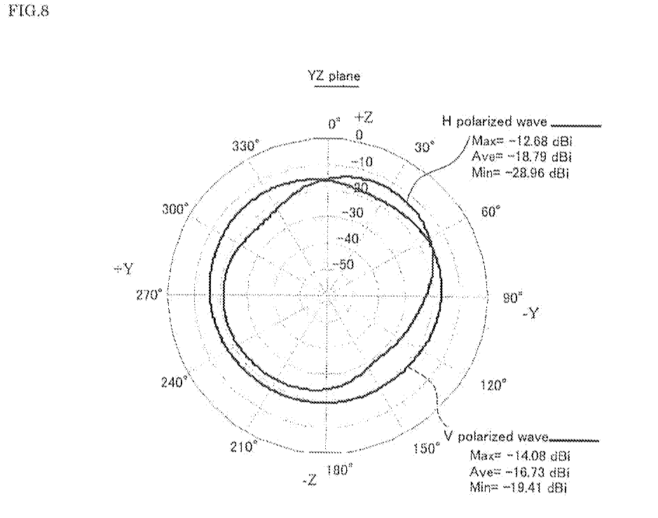

For comparison, as shown in FIG. 5, the results obtained from the same measurement using the antenna device in which a pattern antenna having the inverse F-type antenna pattern II is formed on the base material 3 is shown in FIG. 6. In addition, as shown in FIG. 7, the results obtained from the same measurement using the antenna device in which a pattern antenna having the loop antenna pattern 21 is formed on the base material 3 is shown in FIG. 8. The open surface area and the shape of the loop antenna pattern 21 are set in the same manner as those of the impedance control section 7 according to the present embodiment.

The capacitances or the inductances of the passive components 6d and 6e connected to the matching circuit section 5 and the antenna pattern in these comparative examples are shown in FIG. 5 and FIG. 7, respectively.

In the comparative example of the inverse F-type antenna pattern 11, it is understood that the antenna gains of a horizontally polarized wave and a vertically polarized wave indicate low levels of −15.67 dBi and −12.77 dBi, respectively, as shown in FIG. 6.

In the comparative example of the loop antenna pattern 21, as shown in FIG. 8, when the antenna gain is taken as an overall level based on both of the horizontally polarized wave of −14.08 dBi and the vertically polarized wave of −12.68 dBi, this comparative example is not so improved over the comparative example of the inverse F-type antenna pattern 11.

Compared to these comparative examples, in the antenna device 1 of the present embodiment, the antenna gains of a horizontally polarized wave and a vertically polarized wave indicate −8.78 dBi and −9.318 dBi, respectively, as shown in FIG. 4. Both antenna gains are less than −10 dBi and are improved by 3 to 5 dBi, whereby it is found that the directivity is improved to a substantially omnidirectional level. Thus, in the present embodiment, settings such as inductance component are appropriately made by the open-end of the impedance control section 7, whereby characteristic improvement depending on the peripheral state can be achieved without increasing the open surface area and the effective length.

Accordingly, since in the antenna device 1 of the present embodiment, the antenna element 4 includes the impedance control section 7, which is annularly formed (loop-formed) and has the passive components 6a to 6c connected thereto, on an opened leading end section, the overall impedance control section 7 including the passive components 6a to 6c serves as the open element of an antenna, and thereby the impedance at the distal end can be controlled. As a result, the antenna device 1 can provide a desired frequency tuning depending on the settings of the passive components 6a to 6c, the shape of the impedance control section 7, and the like, and characteristic improvement and reduction in size of the device can be achieved.

In addition, since the impedance control section 7 is divided into a plurality of groups by a plurality of the passive components 6a to 6c that are connected together and spaced apart from each other, the second element 9b to the fourth element 9d as a plurality of antenna elements, of which the elongation direction, length, and the like are properly divided and arranged by appropriately setting the divided position of the passive components 6a to 6c, are obtained, and thereby the influence of a ground plate, a peripheral component, and the like can be reduced.

Furthermore, the impedance control section 7 is arranged so as to surround the other circuit 8 provided on the base material 3, and thereby the open surface area can be set as large as possible.

The present disclosure is not limited to the aforementioned embodiment and various modifications may be made without departing from the spirit of the present disclosure.

For example, while the antenna characteristics of the first element 9a described above can be improved by adjusting the length thereof, not only a linear pattern employed in the first element 9a of the foregoing embodiment but also a length-adjustable pattern such as a meander shape or the like may also be employed.

Also, for the methods of forming an antenna element, a method of forming an antenna element by attaching a conductor on a base material, a printed circuit substrate technique in which an antenna element is formed by printing an ink mixed with a conductor powder on a base material, a photolithography technique in which an antenna element is formed by depositing a conductor on a base material and removing an unnecessary portion by etching thereafter, or a technique in which a conducting wire is erected on a base material and bent into a desired shape may be employed.

What is claimed is:

1. An antenna device comprising:
a base material having a power feed section to which a power feed line is connected;
an antenna element connected to the power feed section; and
a matching circuit section, which is connected to the power feed section and the antenna element and matches the reactance of the antenna element and that of the power feed line with each other,
wherein the antenna element comprises an impedance control section, which is annularly formed and has a passive component connected thereto, on an opened leading end section.

2. The antenna device according to claim 1, wherein the impedance control section is divided into a plurality of groups by a plurality of the passive components that are connected together and spaced apart from each other.

3. The antenna device according to claim 1, wherein the impedance control section is arranged so as to surround other circuit provided on the base material.
